(19) United States
(12) Patent Application Publication
(10) Pub. No.: US 2005/0138409 A1
(43) Pub. Date: Jun. 23, 2005

(54) Securing an electronic device

(76) Inventors: Tayib Sheriff, Cedar Park, TX (US); Minda Zhang, Westford, MA (US); Moinul H. Khan, Austin, TX (US); David M. Wheeler, Gilbert, AZ (US); John P. Brizek, Placerville, CA (US); Mark N. Fullerton, Austin, TX (US)

Correspondence Address: TROP PRUNER & HU, PC, 8554 KATY FREEWAY, SUITE 100, HOUSTON, TX, 77024, US

(21) Appl. No.: 10/745,469

(22) Filed: Dec. 22, 2003

(51) Int. Cl. H04L 9/00

(52) U.S. Cl. 713/200

(57) ABSTRACT

An apparatus includes a processor to control a boot-up of an electronic device in response to a detection of tampering with the device. In some embodiments of the invention, the processor may detect tampering by authenticating a source of a boot image used during the boot-up; and the processor may detect tampering by verifying the integrity of the boot image. In some embodiments of the invention, the processor may control a transition of the electronic device from a first state to a second power state in response to a detection of tampering with the device. The electronic device consumes more power in the second power state than in the first power state.

### BACKGROUND

The invention generally relates to securing an electronic device, such as a computing or communication device, for example.

Portable computing or communication devices, such as cellular telephones, personal digital assistants (PDAs), pagers, etc. may be key components in the future for purposes of conducting mobile commerce. However, as compared to their non-portable counterparts, portable devices typically use relatively simpler operating systems and applications that are vulnerable to tampering and possibly malicious attacks. The tampering may compromise the integrity of the portable device, leading to possible user dissatisfaction, malfunction of the portable device, malfunction of the portable device's communication network (a cellular network, for example) and monetary damage.

Thus, there is a continuing need for better ways to secure an electronic device to safeguard against tampering.

### BRIEF DESCRIPTION OF THE DRAWING

FIGS. 1, 8 and 9 are flow diagrams depicting techniques to boot-up a portable device in accordance with embodiments of the invention.

FIG. 2 is a block diagram of a portable device according to an embodiment of the invention.

FIG. 3 is an illustration of a platform image stored in a memory of the portable device according to an embodiment of the invention.

FIG. 4 is a flow diagram of a technique to generate a security agent according to an embodiment of the invention.

FIG. 5 is a block diagram illustrating the generation of a digital signature from a boot image according to an embodiment of the invention.

FIG. 6 is an illustration of a security agent according to an embodiment of the invention.

FIG. 7 is a schematic diagram of an application processor of the portable device according to an embodiment of the invention.

FIG. 10 is a flow diagram depicting a technique to determine the authenticity of a source of a boot image of the portable device according to an embodiment of the invention.

FIG. 11 is a flow diagram depicting a technique to determine the integrity of the boot image according to an embodiment of the invention.

FIG. 12 is a flow diagram depicting a technique to control a transition of an electronic device from a power conservation state to a higher power consumption state according to an embodiment of the invention.

### DETAILED DESCRIPTION

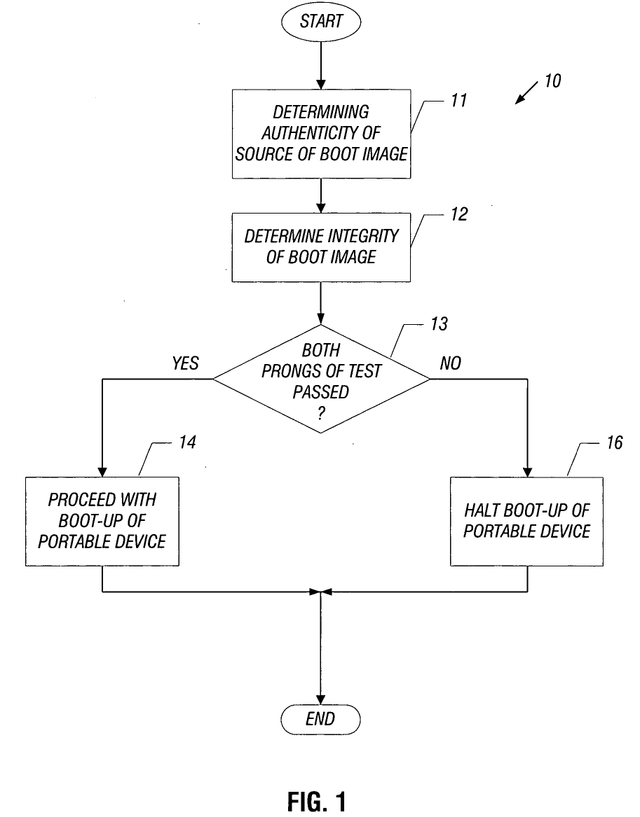

In accordance with an embodiment of the invention, an electronic device, such as a portable computing or communication device (herein called a “portable device”), controls its boot-up based on the device's detection of tampering with the device. More specifically, in accordance with some embodiments of the invention, the portable device performs a technique 10, generally depicted in FIG. 1, that uses a two prong test to determine whether tampering has occurred. First, the portable device determines (block 11) the authenticity of a source of a boot image used in the boot-up of the portable device for purposes of determining whether the source can be trusted. As a more specific example, the source may be a memory of the portable device in which the boot image is stored or a host that provides the boot image to the portable device via a download. In some embodiments of the invention, the boot image may be the initial boot image that is executed by the portable device 20 when the device 20 boots up. By authenticating the source, the portable device is able to detect, for example, whether a memory that stores the boot image has been reprogrammed or replaced; or whether, for example, an unrecognized download source is being used to download the boot image into the portable device.

After checking for authenticity, the portable device determines (block 12) the integrity of the boot image. If the portable device determines (diamond 13) that both the authenticity and integrity prongs of the test have been passed, then the portable device proceeds (block 14) with the boot-up of the portable device. Otherwise, in accordance with some embodiments of the invention, the portable device has detected possible tampering and halts (block 16) the remaining boot-up of the device.

In the context of this application, the term “boot-up” refers to the start-up and initialization of the portable device occurring in response to either a reset or power up of the device. The “boot-up” includes the activities of the portable device prior to and during the loading of its operating system, may include initializing and recognizing hardware after a reset or power up of the device and may include checking hardware for status information and errors after a reset or power up of the device.

Thus, the above-described secured boot-up provides the advantage of determining at an early stage of the portable device's operation whether tampering with the source (a memory, for example) of the portable device has occurred or whether an authorized source is attempting to download a boot image into the device. If such tampering is detected, then the portable device minimizes the effects of the tampering by halting further normal operation of the device. As described further below, in some embodiments of the invention, the portable device uses such elements as non-modifiable memories, a trust co-processor, a public key identifying the source of the boot image and a digital signature of the boot image to secure the boot-up of the device.

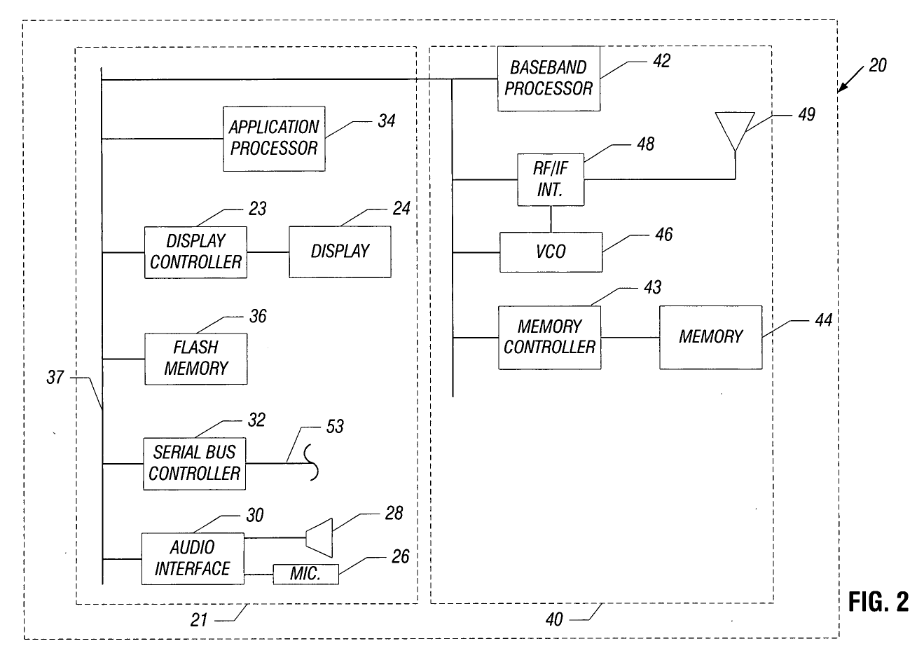

In some embodiments of the invention, the portable device may be a one-way pager, a two-way pager, a personal communication system (PCS), a personal digital assistant (PDA), a cellular telephone, a portable computer, etc. that may have an architecture that is depicted in FIG. 2 in an exemplary embodiment 20 of the portable device. Referring to FIG. 2, the portable device 20 may include an application subsystem 21 and a communication subsystem 40. The application subsystem 21 provides features and capabilities that are visible and/or used by a user of the portable device 20. For example, the application subsystem 21 may be used for purposes of electronic mail (“e-mail”), calendaring, audio, video, gaming, etc. The communication subsystem 40 may be used for purposes of providing wireless and/or wired communication with other networks, such as cellular networks, wireless local area networks, etc.

For the case in which the portable device 20 is a cellular telephone, the application subsystem 21 may provide an interface to the user of the telephone and thus, provide, among other things, a keypad 33 that the user may use to enter instructions and telephone numbers into the cellular telephone; a display 24 for displaying command options, caller information, telephone numbers, etc.; a microphone 26 for sensing commands and/or voice data from the user; and a speaker 28 that may be used to provide an audible ringing signal to the user, as well as provide an audio stream for audio data that is provided by a cellular network, for example. The application subsystem 21 includes various interfaces for these user interface components, such as, for example, a display controller 23 (for the display 24) and an audio interface 30 (for the speaker 28 and the microphone 26).

The application subsystem 21 also includes an application processor 34 that executes application and operating system program code to provide one or more of the above-described functions of the portable device 20. This code, as well as code to at least boot-up the application subsystem 21 side of the portable device 20 may be stored as a platform image in a memory 36 that is coupled to the bus 37. It is assumed, for purposes of discussion below, that the memory 36 is a flash memory. However, a different type of memory (a read only memory (ROM), programmable ROM (PROM), electrically erasable PROM (EEPROM), etc., as examples) may be used in other embodiments of the invention. The flash memory 36, in some embodiments of the invention, is constructed so that sections of the memory 36 may be designated as one time programmable (OTP) sections that are locked for purposes of preventing unauthorized modification or replacement of a platform image that is stored in the flash memory 36.

Depending on the particular embodiment of the invention, the portable device 20 may include a serial bus controller 32 that is coupled to the bus 37 and interfaces the portable device 20 to a serial bus 53. This serial bus 53 may be used to download the boot image to the portable device, in some embodiments of the invention, as described below.

The application subsystem 21 represents one out of many different possible embodiments of the portable device 20 in accordance with the invention. Thus, in some embodiments of the invention, the application subsystem 20 may include different and/or additional components, such as a camera, a global positioning system (GPS) receiver, etc., as just a few examples.

In some embodiments of the invention, the communication subsystem 40 includes a baseband processor 42 (a digital signal processor, for example) that establishes the particular communication standard for the portable device 20. The communication subsystem 40, in some embodiments of the invention, may be a wireless interface. For example, if the portable device 20 is a cellular telephone, then the communication subsystem 40 provides a cellular network interface, a wireless interface, for the portable device 20. For this wireless interface, the baseband processor 42 may establish a code division multiple access (CDMA) cellular radiotelephone communication system, or a wide-band CDMA (W-CDMA) radiotelephone communication system, as just a few examples. The W-CDMA specifically has been proposed as a solution to third generation (“3G”) by the European Telecommunications Standards Institute (ETSI) as their proposal to the International Telecommunication Union (ITU) for International Mobile Telecommunications (IMT)-2000 for Future Public Land Mobile Telecommunications Systems (FPLMTS). The baseband processor 42 may establish other telecommunication standards such as Global System for Mobile (GSM) Communication, ETSI, Version 5.0.0 (December 1995); or General Packet Radio Service (GPRS) (GSM 02.60, version 6.1), ETSI, 1997.

The baseband processor 42 is coupled to a radio frequency/intermediate frequency (RF/IF) interface 48 that forms an analog interface for communicating with an antenna 49 of the communication subsystem 40. A voltage controlled oscillator (VCO) 46 is coupled to the RF/IF interface 48 to provide signals having the appropriate frequencies for modulation and demodulation, and the baseband processor 42 controls the VCO 46 to regulate these frequencies, in some embodiments of the invention.

Among the other features of the communication subsystem 40, in some embodiments of the invention, the subsystem 40 may include a memory 44 (a DRAM memory or a flash memory, as a few examples) that is coupled to the baseband processor 42. The memory 44 may store program instructions 41 and/or data.

Although the portable device 20 is described in an example as being a cellular telephone, in other embodiments of the invention, the portable device may be another type of portable device, such as, for example, a PDA, PCS, portable computer, etc.

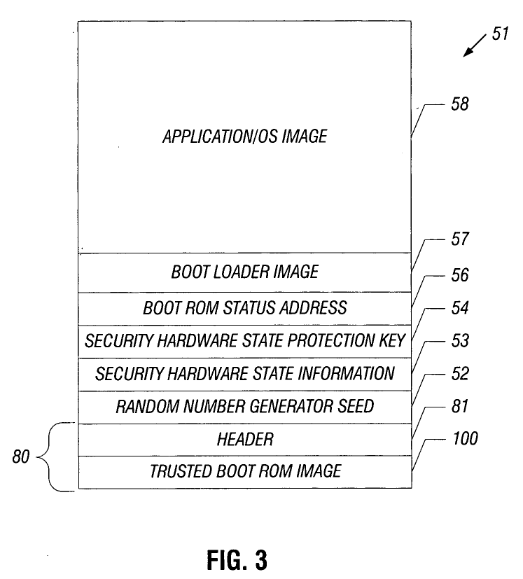

In some embodiments of the invention, the original equipment manufacturer (OEM) of the portable device 20 downloads a platform image onto the device 20. This platform image includes boot-up, application and operating system instructions and related data. As a more specific example, FIG. 3 depicts an exemplary platform image 51 that may be programmed into the flash memory 36 of the portable device 20. The platform image 51 includes a boot image 100 that is the image used in the initial boot-up of the portable device 20 and is assumed herein to be the image whose integrity is verified by the device 20 pursuant to the technique 10 (FIG. 1). The boot image 100 may includes tables, program code, variable space, etc., all of which are associated with the initial boot-up of the portable device 20.

The boot image 100 is part of an initial security agent 80 that the OEM downloads into the portable device 20. In addition to the boot image 100, the security agent 80 includes a header 81 that is used by the application processor 34 to verify the integrity of the boot image 100 and the authenticity of the source of the boot image 100, as further described below.

In some embodiments of the invention, the OEM creates the header 81 through the execution of a trusted secure tools builder application program on a trusted computer platform. As described further below, the header 81 includes various security features, such as a digital signature of the boot image 100 and a hash of a public key that uniquely identifies the OEM, the source of the boot image 100.

In addition to the header 81, the platform image 51 may include a field 52 that contains a random number generator seed that is used by the portable device 20 for purposes of authenticating the device 20; a field 53 that stores the state of the portable device 20 at the last power down of the device 20; a field 54 that contains a key to secure the state information stored in the field 53; a field 56 that stores an address of a location in the flash memory 36 for storing the results of the two-prong tampering test performed by the portable device 20; a boot loader image 57 and an application/operating system image 58.

As its name implies, the boot loader image 57 contains instructions to cause the portable device 20 to load and initialize and the operating system and application programs of the portable device 20. The boot loader image 57, through the execution of program code in the image 57, may also add additional security features to the portable device 20. If the portable device 20 fails the security features established by the boot loader image 57, then control does not transfer to the execution of the application/operating system image 58. Thus, in some embodiments of the invention, the portable device 20 may employ a layered boot-up flow, with a security failure at any particular layer halting the boot-up. The security features that are used in connection with the boot image 100, the first layer, are described herein. However, the same security features may also be applied to the other layers of the transitive trusted boot-up process.

In some embodiments of the invention, the OEM may program the portable device 20 using an external communication link to the device 20, such as the serial bus 53 (FIG. 2). As described in more detail below, in some embodiments of the invention, the OEM programs the portable device 20 after the first boot-up of the device 20. This programming involves downloading the platform image 51 from the OEM's trusted computer platform into a random access memory (RAM) of the portable device 20 and also involves the subsequent copying of the downloaded data into the flash memory 36.

During this programming, the portable device 20 adheres to the same security checks as set forth in the technique 10 (FIG. 1) to prevent an unauthorized source from installing a rogue image on the device 20 or modifying data stored on the device 20. More specifically, during the initial boot-up of the portable device 20, the device 20 confirms the authenticity of the source of the image 100. This source should be the OEM's trusted platform. After this confirmation, the portable device 20 downloads the platform image 51 from the trusted computer platform of the OEM into a RAM memory of the portable device 20, such as an internal memory of the application processor 34, described below. The portable device 20 then uses the header 81 to determine the integrity of the boot image 100, and if this integrity test is passed, control transfers to the execution of the boot image 100. In some embodiments of the invention, the boot image 100 contains program code to cause the portable device 20 to, on the initial boot-up, copy the platform image 51 into the flash memory 36 and then program bits of the flash memory 36 to lock the flash memory 36 from being modified.

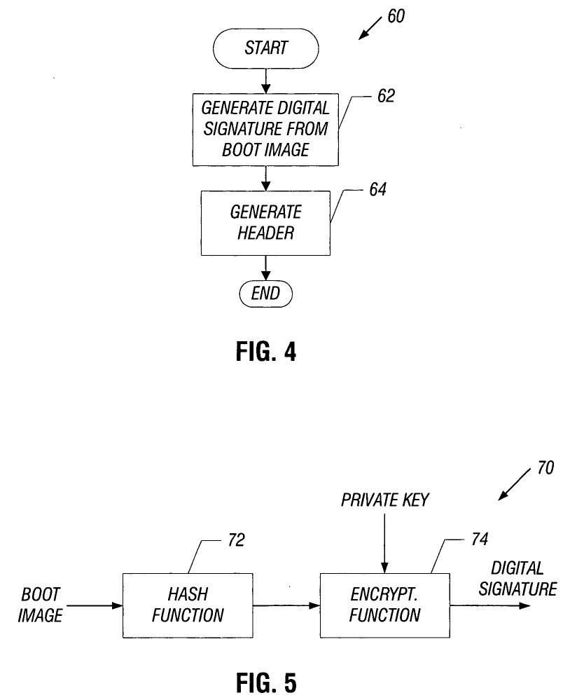

In some embodiments of the invention, the trusted OEM computer platform may use a technique 60 that is depicted in FIG. 4 to generate the security agent 80. First, the OEM computer platform generates (block 62) a digital signature, a component of the header 81, from the boot image 100 and thereafter generates (block 64) the header 81 for the security agent 80. More specifically, referring to FIG. 5, the OEM computer platform may generate the digital signature by processing the boot image 100 with a hash function 72. The OEM computer platform then, using a private key, applies a crytpographic function 74 to the resultant hash to produce the digital signature.

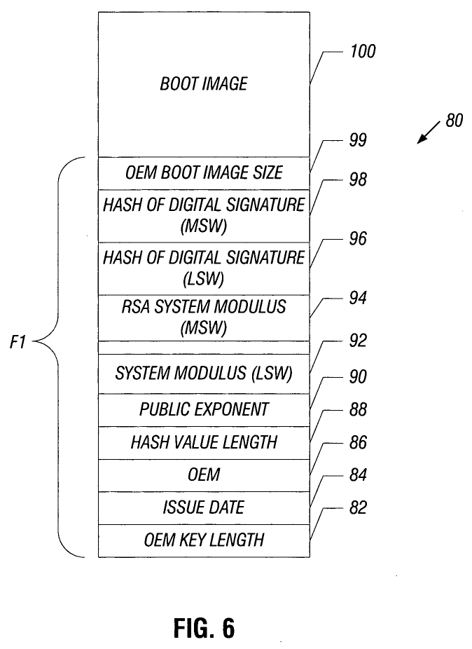

FIG. 6 depicts an exemplary security agent 80. The header 81 includes several fields 82-99 that, as an example, may each be a word in length. The field 82 may indicate a length of the private key used to form the digital signature. The field 84 may include data that indicates an issue date for the boot image 100. The field 86 may include data that indicates a public identification number for the OEM. The field 88 may include data that indicates a length of the hash value produced via the hash of the boot image. The fields 90-94 may include data that collectively forms the public key of the OEM. For example, the field 90 may include data that is a hash of the public exponent of the public key; and the fields 92 and 94 may indicate a hash of the least significant word (field 92) and the most significant word (field 94) of a system modulus of the public key.

In some embodiments of the invention, the header 81 may also include fields 96 and 98 that indicate the least significant and most significant words, respectively, of the encrypted hash of the boot image 100. In other words, the fields 96 and 98 indicate the least significant and most significant, respectively, words of the digital signature. Finally, in some embodiments of the invention, the header 81 may include a field 99 that includes data to indicate the size of the boot image 100.

FIG. 6 is merely an example of an embodiment of the header 81. However, many other variations are possible, in other embodiments of the invention.

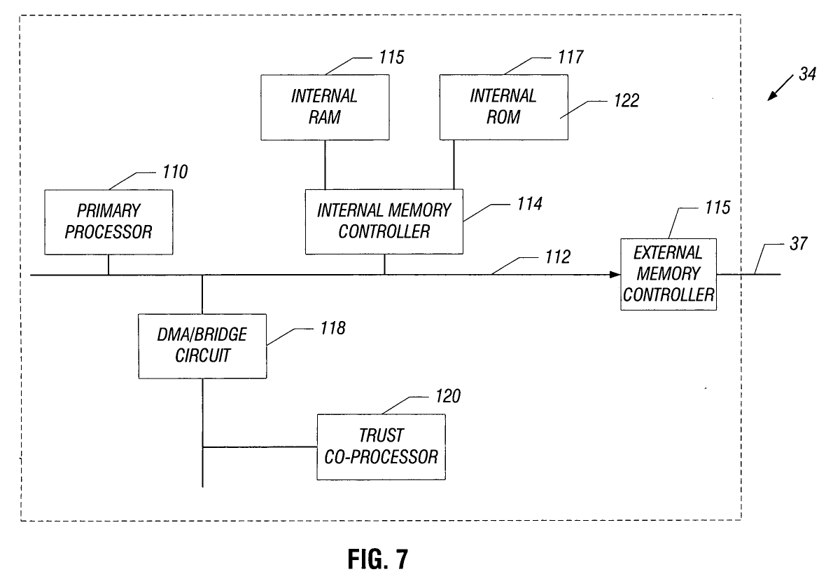

In some embodiments of the invention, the application processor 34 may have a structure similar to the one that is depicted in FIG. 7. As shown, the application processor 34 may include a primary processor 110, a first processing unit; and a trusted processor (herein called the “trust co-processor 120”), a second processing unit. Besides the trust co-processor 120 and the primary processor 110, the application processor 34 may also include a direct memory access (DMA) and bridge circuit 118 that connects the trust co-processor 120 to an internal bus 112, as well as controls up memory transfer operations that occur over the internal bus 112. In some embodiments of the invention, the application processor 34 includes an external memory controller 115 that serves as a bridge between the internal bus 112 and the external bus 37 (see FIG. 2) of the application subsystem 21. Thus, due to this arrangement, both the primary processor 110 and the trust co-processor 120 may access the flash memory 36, in some embodiments of the invention.

The application processor 34 also includes an internal memory controller 114 that establishes communication between the internal bus 112 and two memories: an internal random access memory (RAM) 115 and an internal read only memory (ROM) 117. As a more specific example, in some embodiments of the invention, the internal RAM 115 may be a static RAM (SRAM). However, other types of random access memories may be used in other embodiments of the invention. The RAM 115 and ROM 117 are connected to an internal bus 117 of the application processor 34 by the internal memory controller 114.

The ROM 117 provides a trusted memory for purposes of forming the core root of trust of the portable device 20, in some embodiments of the invention. More specifically, in some embodiments of the invention, the ROM 117 contains program code that is located at the entry point at boot-up and provides the general flow that is set forth in the technique 10 (see FIG. 1). More specifically, in some embodiments of the invention, in response to being booted up, the primary processor 110 executes this instruction code to cause the primary processor 110 to at least initiate the authenticity and integrity checks and then control the remainder of the boot-up accordingly.

In general, the primary processor 110 executes the boot application and operating system code for the application processor 34, in some embodiments of the invention.

The trust co-processor 120, in some embodiments of the invention, verifies the authenticity of the source of the boot image 100. This verification may be initiated at the request of the primary processor 110, for example. The use of the trust co-processor 120 for performing this authenticity check may be advantageous, for example, to off-load cryptographic-related functions from the primary processor 110 and provide a trusted agent to securely perform these functions.

In some embodiments of the invention, instead of executing instructions that are stored in the ROM 117, the primary processor 110 may be “hardwired” (programmed via microcode, for example) to perform functions related to the secure boot-up of the portable device 20. Likewise, in some embodiments of the invention, the trust co-processor 120 may be hardwired to perform functions related to the secure boot-up of the portable device 20.

In some embodiments of the invention, the trust co-processor 120 or primary processor 110 may access a cryptolibrary, a software library of cryptographic functions provided by Intel®, for purposes of authenticating the source of the boot image 100.

In some embodiments of the invention, the trust co-processor 120 stores a hash of the public key used to authenticate the source of the boot image 100. For example, the trust co-processor 120 may store this hash in a fuse, ROM or flash memory of the trust co-processor 120. In other embodiments of the invention, the trust co-processor 120 may store the hash of the public key in another memory such as in the internal ROM 117 of the application processor 34 or in the flash memory 36 (see FIG. 2), for example.

The trust co-processor 120, in some embodiments of the invention, may contain microcode to configure the co-processor 120 to authenticate the source of the boot image 100. Alternatively, in other embodiments of the invention, the trust co-processor 120 may execute instruction code that is stored in the internal ROM 117 of the application processor 34 for purposes of causing the trust co-processor 102 to authenticate the source of the boot image 100.

In some embodiments of the invention, the trust co-processor 120 configures itself on boot-up.

Other variations are possible for mechanisms to authenticate the source of the boot image 100. For example, in some embodiments of the invention, the primary processor 110 may be used in place of the trust co-processor 120 to authenticate the source of the boot image 100.

In some embodiments of the invention, the trust co-processor 120 may also verify the integrity of the boot image 100. In this manner, in some embodiments of the invention, the trust co-processor 120 may contain microcode that configures the co-processor 102 to authenticate the integrity of the boot image 100. Alternatively, in other embodiments of the invention, the trust co-processor 120 may execute instruction code that is stored in the internal ROM 117 for purposes of causing the trust co-processor 102 to authenticate the source of the boot image 100. Furthermore, in some embodiments of the invention, the verification of the integrity of the boot image 100 may be performed by the primary processor 110.

It is noted that, in some embodiments of the invention, a “closed system” is used to secure the boot-up of the portable device 20 in that no component outside of the application processor 34 is accessed until the time at which control is handed over to the next layer (the boot loader image 57 (FIG. 3), for example) of the transitive trust boot process.

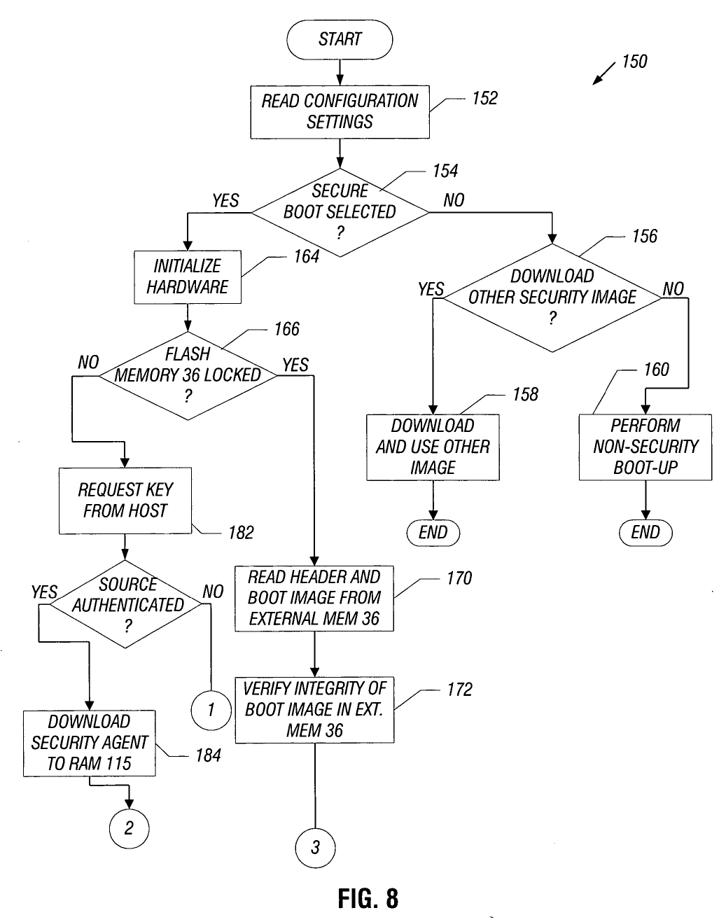

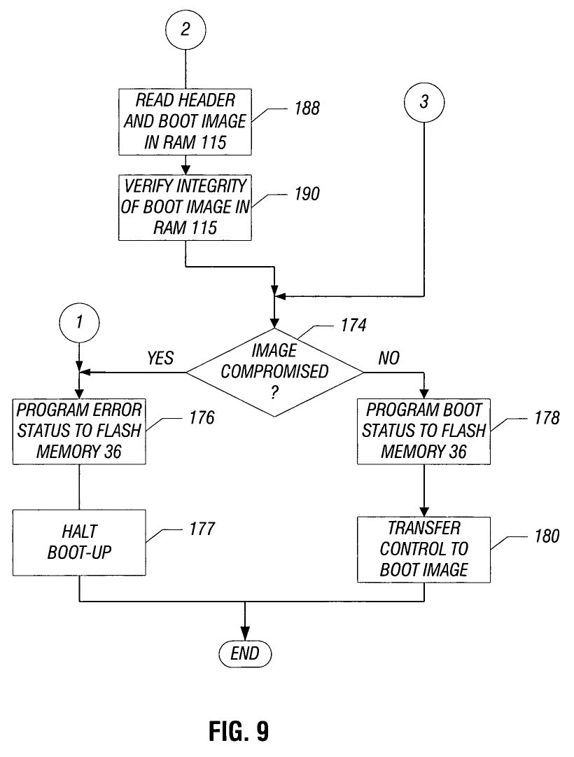

Referring to FIGS. 8 and 9, in some embodiments of the invention, the application processor 34 may perform a technique 150 upon boot-up of the portable device 20. It is noted that one or more of the trust co-processor 120 and the primary processor 110 may execute instructions in the technique 150. Thus, in the following description, references made to the application processor 34 executing instructions to perform the technique 150 mean that either one or both of the trust co-processor 120 and the primary processor 110 execute these instructions. These instructions may be stored in, for example, microcode in the executing entity, the internal ROM 117 of the application processor 34, or another memory, depending on the particular embodiment of the invention.

Pursuant to the technique 150, the application processor 34 reads (block 152) configuration settings for the processor 34. In some embodiments of the invention, these configuration settings may be communicated to the application processor 34 via general purpose input/output (GPIO) input terminals of the processor 34. Alternatively, these settings may be established in other embodiments of the invention via user switches, fuses or a predefined memory location, as just a few examples. The settings may be used to, for example, determine whether to download or not download a security image other than the boot image 100, may be used to select a port of the portable device 20 for downloads, etc.

Subsequently, pursuant to the technique 150, the application processor 34 determines (diamond 154) whether the secure boot mode of the processor 34 has been selected. As an example, in some embodiments of the invention, the secure boot features of the processor 34 may be selected by selectively blowing fuses of the portable device 20 at the OEM's facility. If the secure boot feature of the application processor 34 has not been selected, then the processor 34 determines (diamond 156) whether another security-based boot image should be downloaded. If so, the application processor 34 downloads and uses the other security-based boot image, as depicted in block 158. Otherwise, the application processor 34 performs a conventional non-security boot process, as depicted in block 160.

If the secure boot features of the processor 34 are selected (diamond 154), then the processor 34 begins the secure boot process. More specifically, the processor 34 initializes (block 164) the hardware of the portable device 20. For example, the application processor 34, in some embodiments of the invention, may initialize at least the various components of the application subsystem 21.

Next, the application processor 34 determines (diamond 166) whether the flash memory 36 has been locked. This locked status may be used to indicate to the application processor 34 whether this is the first ever boot-up of the portable device 20. Thus, the lock state of the flash memory 36 determines the source of the boot image 100: the flash memory 36 (when the flash memory 36 is locked) or the OEM computer platform (when the flash memory 36 is unlocked). Both sources may be identified by the same public key, in some embodiments of the invention. If the flash memory 36 is locked, then the application processor 34 reads (block 170) the header 81 and boot image 100 from the flash memory 36. The application processor 34 then verifies the authenticity of the source of the boot image and verifies the integrity of the boot image 100, as depicted in block 172.

Subsequently, the application processor 34 determines (diamond 174) whether the boot image 100 has been compromised (i.e., determines whether either the authenticity or integrity test has failed), and if not, the processor 34 programs the boot status to the flash memory 36, as depicted in block 178, and transfers control to the execution of the boot image, as depicted in block 180. However, if the application processor 34 determines in diamond 174 that the boot image 100 has been compromised, then the processor 34 programs (block 176) the corresponding error status in the flash memory 36 and halts (block 177) the technique 150 to halt the boot-up of the portable device 20.

If the application processor 34 determines (diamond 166) that the flash memory 36 is unlocked, then the processor 34 prepares to download the boot image 100 from a trusted host platform. This download may occur over the serial bus 53 (FIG. 2), for example. To authenticate the source for the download, the application processor 34 communicates with the host platform (via the serial link 53, for example) to request a public key from the host platform. The application processor 34 then determines, based on the provided public key (or the hash of this key, for example), whether the host platform is authentic, as depicted in diamond 184. In some embodiments of the invention, the application processor 34 checks the provided key against a copy of the key stored in the OTP section of the flash memory 36. If the authentification fails, control transfers to block 176 so that the boot is halted and the error status is programmed into the flash memory 36. Otherwise, if the host platform is authenticated, then the application processor 34 downloads the security agent 80 (i.e., the boot image and header) into the RAM 115, as depicted in block 184, via the serial link 53.

Subsequently, the application processor 34 reads (block 188) the header and boot image from the RAM 115 and then verifies (block 190) the integrity of the boot image in the RAM 115. Control then proceeds to diamond 174 in which the application processor 34 determines whether the boot image has been compromised, as described above.

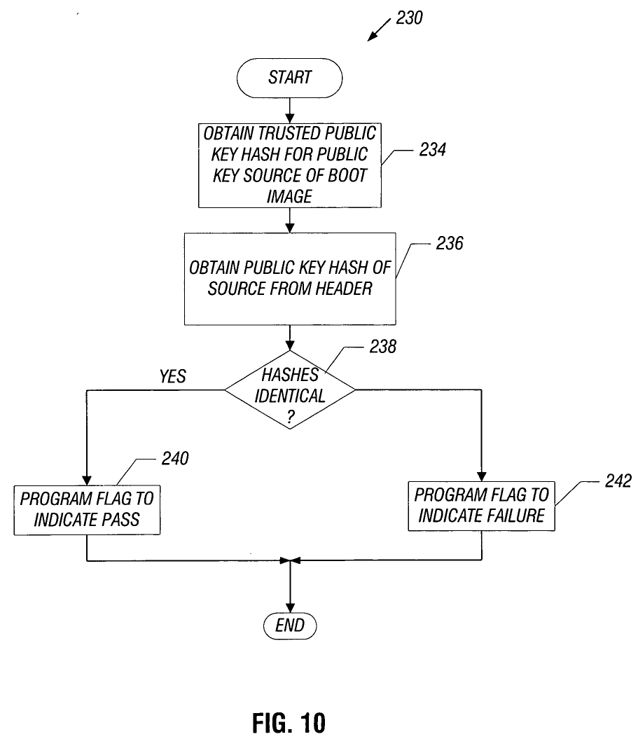

Referring to FIG. 10, in some embodiments of the invention, the application processor 34 (via the trust co-processor 120, for example) may perform a technique 230 for purposes of verifying the authenticity of the source of the boot image 100. Pursuant to the technique 230, the application processor 34 obtains (block 234) the trusted public key hash for the source of the boot image 100 and obtains (block 236) the public key hash of the source from the header 81. Subsequently, the application processor 34 compares the hashes, as depicted in block 238, to determine if the hashes are identical. If the hashes are not identical, then the application processor 34 programs (block 242) a flag (for example) to indicate the failure of the authenticity. Otherwise, the application processor 34 programs (block 240) the flag to indicate that the authenticity was verified. In some embodiments of the invention, the portable device 20 may store the trusted public key hash in the ROM 117, or trust co-processor 120, depending on the particular embodiment of the invention.

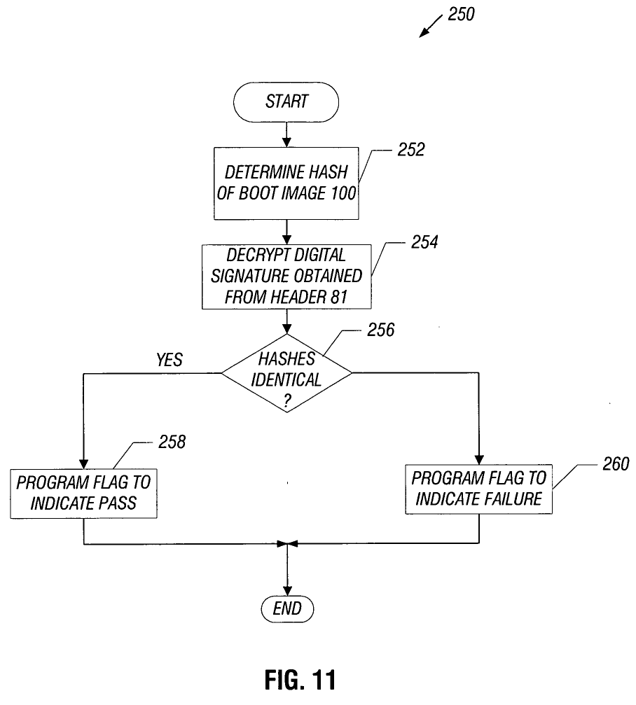

FIG. 11 depicts an exemplary technique 250 that may be performed by the application processor 34, in some embodiments of the invention, for purposes of verifying the integrity of the boot image 100. Pursuant to the technique 250, the application processor 34 computes (block 252) the hash of the boot image 100 and subsequently decrypts (block 254) the digital signature from the header 81. Lastly, pursuant to the technique 250, the application processor 34 determines (block 256) whether the decrypted digital signature is identical to the hash of the boot image 100. If not, then the application processor 34 may program (block 260) a flag (for example) to indicate failure of the integrity prong of the tampering test. Otherwise, the application processor 34 programs (block 258) the flag to indicate that the boot image 100 passed the integrity prong of the tampering test.

Other embodiments are within the scope of the following claims. For example, in some embodiments of the invention, the transitive trusted boot technique described herein may be used to secure the boot-up of an electronic device (a desktop computer, for example) other than a portable device. Furthermore, the techniques described in the embodiments herein are not limited to techniques to secure the boot-up of an electronic device.

For example, in some embodiments of the invention, the techniques described above may be used to secure the transition of an electronic device from a power conservation state (a “sleep state” or a “hibernation state,” as examples) to a higher power consumption state (the normal state of the electronic device when fully activated, for example). Thus, in accordance with these embodiments of the invention, the electronic device controls its transition from a power conservation state to a higher power consumption state in response to detecting tampering with device.

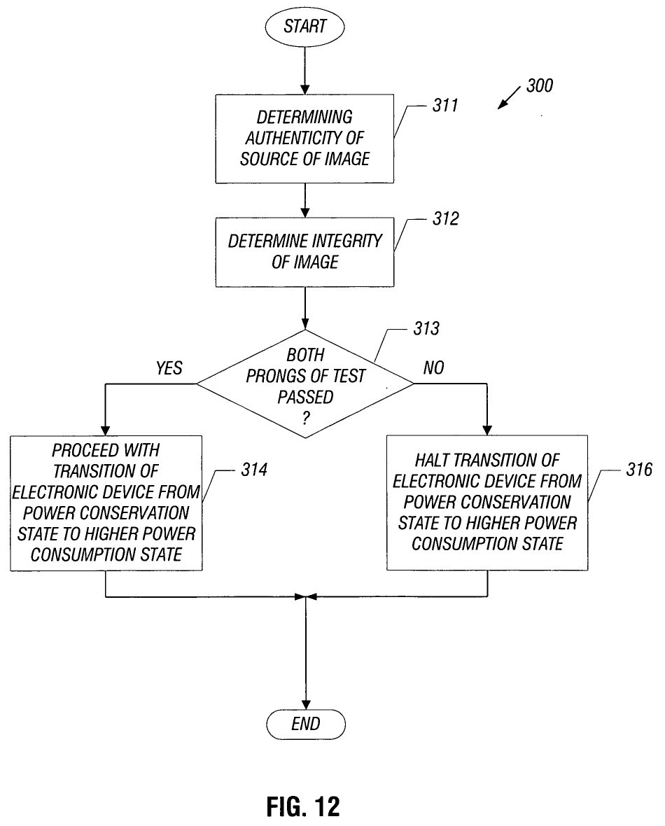

More specifically, in accordance with some embodiments of the invention, the electronic device may perform a technique 300 that is generally depicted in FIG. 12. In accordance with this technique 300, the electronic device determines (block 311) the authenticity of a source (a memory, for example) of an image. This image may be, for example, an image that is used in the transition of the electronic device from the power conservation state to the higher power consumption state. The electronic device may use, for example, a technique similar to the technique 230 depicted in FIG. 10 to authenticate the source. After checking for authenticity, the electronic device determines (block 312) the integrity of the image. As examples, the electronic device may perform the integrity check by using a technique similar to the technique 250 depicted in FIG. 11. If the electronic device determines (diamond 313) that both the authenticity and integrity prongs of the test have been passed, then the electronic device proceeds (block 314) with the boot-up of the electronic device. Otherwise, in accordance with some embodiments of the invention, the electronic device has detected possible tampering and halts (block 316) the transition of the device from the power conservation state to the higher power consumption state.

As a more specific example, in some embodiments of the invention, the electronic device may be portable device that has a structure that is similar to the one depicted in FIGS. 2 and 7. Thus, in some embodiments of the invention, the electronic device may have a wireless interface (a cellular interface, for example) and may be a wireless communication device. Furthermore, in some embodiments of the invention, the authenticity and integrity checks and the general control of the transition of the electronic device in response to these checks may be performed by components of the electronics device similar to the manner in which the components of the portable device 20 control its boot-up. In some embodiments of the invention, the electronic device may include a processor, such as the application processor 34 (FIG. 2), to execute instructions that are stored in a storage medium (a ROM, example) to cause the processor to perform the technique 300.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

1. A method comprising:
controlling a boot-up of an electronic device in response to detecting tampering with the device.

2. The method of claim 1, wherein the detecting tampering comprises:
authenticating a source of a boot image used in the boot-up of the electronic device.

3. The method of claim 2, wherein the authenticating comprises:
authenticating a memory that stores the boot image.

4. The method of claim 2, wherein the authenticating comprises:
authenticating a host platform that provides the boot image for download.

5. The method of claim 2, wherein the authenticating comprises:
determining whether a hash provided by the source is identical to a trusted hash of a public key stored in the electronic device.

6. The method of claim 1, wherein the detecting tampering comprises:
determining an integrity of a boot image used in the boot-up of the electronic device.

7. The method of claim 6, wherein the determining the integrity comprises:
processing the boot image to produce a first digital signature; and
comparing the first digital signature to a second digital signature.

8. The method of claim 7, wherein the processing comprises generating a hash from the image.

9. The method of claim 7, further comprising:
decrypting data from a header associated with the image to generate the second digital signature.

10. The method of claim 1, wherein the controlling comprises:
controlling a download of a boot image during the boot-up in response to the determination.

11. The method of claim 1, wherein the controlling comprises:
selectively halting the boot-up in response to the determination.

12. An apparatus comprising:
a processor to control a boot-up of an electronic device in response to a detection of tampering with the device.

13. The apparatus of claim 12, wherein the electronic device comprises a portable device.

14. The apparatus of claim 12, wherein the apparatus comprises a wireless communication device.

15. The apparatus of claim 12, wherein the processor determines whether the image is authentic in response to a first digital signature of a boot image.

16. The apparatus of claim 15, wherein the processor comprises:
a first processing unit to boot-up the electronic device; and
a second processing unit separate from the first processing unit to detect whether tampering has occurred with the electronic device.

17. The apparatus of claim 16, further comprising:
a read only memory internal to the processor and storing instructions to cause the second processing unit to detect tampering with the device.

18. The apparatus of claim 16, further comprising:
a memory storing a public key,
wherein the second processing unit compares the public key stored in the memory with a public key of a header associated with a boot image to determine whether a source of the boot image is authentic.

19. The apparatus of claim 18, wherein the memory comprises a read only memory.

20. The apparatus of claim 12, wherein the processor decrypts data from a header associated with a boot image to generate a digital signature and compares the generated digital signature to a digital signature present in a header associated with the boot image to determine an integrity of the image.

21. A system comprising:
a wireless interface; and
a processor to control a boot-up of the system in response to a detection of tampering with the system.

22. The system of claim 21, wherein the wireless interface comprises an antenna.

23. The system of claim 21, wherein the wireless interface comprises a cellular interface.

24. The system of claim 21, wherein the processor decrypts data from a header associated with a boot image to generate a digital signature and compares the generated digital signature to a digital signature present in a header associated with the boot image to determine an integrity of the image.

25. The system of claim 21, wherein the processor compares a first public key with a second public key of a header associated with a boot image to determine whether the image is authentic.

26. An article comprising a storage medium readable by a processor-based system, the storage medium storing instructions to cause the processor-based system to:
control boot-up of the system in response to a detection of tampering with the system.

27. The article of claim 26, the storage medium storing instructions to cause the processor-based system to:
determine an integrity of a boot image of the system in response to a first digital signature of the image.

28. The article of claim 26, the storage medium storing instructions to cause the processor-based system to:
process a boot image to produce a first digital signature, and
compare the first digital signature to a second digital signature to determine an integrity of a boot image.

29. The article of claim 26, the storage medium storing instructions to cause the processor-based system to:
determine whether a source of a boot image is authentic in response to a hash of a public key.

30. The article of claim 26, the storage medium storing instructions to cause the processor-based system to:
halt boot-up of the system in response to the detection of tampering.

31. A method comprising:
controlling a transition of an electronic device from a first state to a second state in response to detecting tampering with the device, wherein the power consumption of the electronic device in the first power state is less than the power consumption of the electronic device in the second power state.

32. The method of claim 31, wherein the detecting tampering comprises:
authenticating a source of an image used in the transition of the device from the power conservation state to the higher power consumption state.

33. The method of claim 32, wherein the authenticating comprises:
determining whether a hash provided by the source is identical to a trusted hash of a public key stored in the device.

34. The method of claim 31, wherein the detecting tampering comprises:
determining an integrity of an image used in the transition of the device from the power conservation state to the higher power consumption state.

35. An apparatus comprising:
a processor to control a transition of an electronic device from a first power state to a second power state in response to detecting tampering with the device, wherein the power consumption of the electronic device in the first power state is less than the power consumption of the electronic device in the second power state.

36. The apparatus of claim 35, wherein the apparatus comprises a wireless communication device.

37. The apparatus of claim 35, wherein the processor determines an integrity of an image used in the transition to detect tampering with the device.

38. The apparatus of claim 35, wherein the processor determines an authenticity of a source of an image used in the transition to detect tampering with the device.

39. A system comprising:
a wireless interface; and
a processor to control a transition of the system from a first power state to a second power state in response to detecting tampering with the system, wherein the power consumption of the electronic device in the first power state is less than the power consumption of the electronic device in the second power state.

40. The system of claim 39, wherein the wireless interface comprises a cellular interface.

41. The system of claim 39, wherein the processor tests at least one of an integrity of an image used in the transition of the system and an authenticity of a source of the image to detect tampering with the system.

42. The system of claim 39, wherein the wireless interface comprises an antenna.

43. An article comprising a storage medium readable by a processor-based system, the storage medium storing instructions to cause the processor-based system to:
control a transition of the system from a first power state to a second power state in response to detecting tampering with the system, wherein the power consumption of the electronic device in the first power state is less than the power consumption of the electronic device in the second power state.

44. The article of claim 43, the storage medium storing instructions to cause the processor-based system to:
determine at least an integrity of an image used in the transition to detect tampering.

45. The article of claim 43, the storage medium storing instructions to cause the processor-based system to:
determine at least an authenticity of a source of an image used in the transition to detect tampering.
